(19) United States
(12) Patent Application Publication
(10) Pub. No.: US 2026/0142710 A1
(43) Pub. Date: May 21, 2026

(54) METHOD AND WIRELESS COMMUNICATION DEVICE OF CONFIGURING RADIO RESOURCE IN SATELLITE COMMUNICATION

(71) Applicant: Industrial Technology Research Institute, Hsinchu (TW)

(72) Inventors: Hsin-Hsiang Tseng, New Taipei City (TW); Bo-Yan Chen, Changhua County (TW); Yung-Fang Chen, Taoyuan City (TW); Kai-Lun Cheng, Taoyuan City (TW); Ting-Jung Liang, Hsinchu City (TW)

(73) Assignee: Industrial Technology Research Institute, Hsinchu (TW)

(21) Appl. No.: 19/072,947

(22) Filed: Mar. 6, 2025

(30) Foreign Application Priority Data
Nov. 18, 2024 (TW) 113144255

(51) Int. Cl. H04B 7/06; H04B 7/185; H04L 1/00

(52) U.S. Cl. CPC H04B 7/06952; H04B 7/18539; H04L 1/0003

(57) ABSTRACT

A method and a wireless communication device of configuring a radio resource in satellite communication. The method includes: a first channel matrix gain and a first noise gain are calculated according to precoding information and a first channel matrix; a lookup table is obtained, and the lookup table includes mapping relationships among a modulation coding scheme, a spectral efficiency, and a required signal-to-noise ratio; a first power change for increasing a first spectral efficiency of a first baseband data stream of a first user equipment and a second power change for increasing a second spectral efficiency of a second baseband data stream of the first user equipment are calculated; and in response to the first power change being less than the second power change, a first modulation coding scheme corresponding to the first baseband data stream of the first user equipment is updated.

### CROSS-REFERENCE TO RELATED APPLICATION

This application claims the priority benefit of Taiwan application serial no. 113144255, filed on Nov. 18, 2024. The entirety of the above-mentioned patent application is hereby incorporated by reference herein and made a part of this specification.

### TECHNICAL FIELD

The disclosure relates to a wireless communication technology, and the technical field relates to a method and a wireless communication device of configuring a radio resource in satellite communication.

### BACKGROUND

When a user terminal (UT) communicates with a satellite, if merely one data stream is used for communication between the UT and the satellite, higher-order modulation methods such as 32 amplitude phase shift keying (APSK) may need to be used to maintain the required data transmission rate, error rate, or quality of service (QoS). However, using higher-order modulation significantly increases the total transmission power of the satellite. Therefore, how to reduce the transmission power of the satellite while maintaining the required data transmission rate is one of the important issues in the field.

### SUMMARY

The disclosure provides a method and a wireless communication device of configuring a radio resource in satellite communication, which may save power consumption of a satellite communication system.

A method of configuring a radio resource in satellite communication according to the disclosure includes: precoding information for hybrid beamforming and a first channel matrix corresponding to a first user equipment (UE) are obtained; a first channel matrix gain and a first noise gain are calculated according to the precoding information and the first channel matrix; a lookup table is obtained, and the lookup table includes mapping relationships among a modulation coding scheme (MCS), a spectral efficiency, and a required signal-to-noise ratio (SNR); a first power change for increasing a first spectral efficiency of a first baseband data stream signal of the first UE and a second power change for increasing a second spectral efficiency of a second baseband data stream signal of the first UE are calculated according to the first channel matrix gain, the first noise gain, and the lookup table; and in response to the first power change being less than the second power change, a first MCS corresponding to the first baseband data stream signal of the first UE is updated.

In an embodiment of the disclosure, the step of updating the first MCS corresponding to the first baseband data stream signal of the first UE includes: a first spectral efficiency corresponding to the first baseband data stream signal of the first UE is increased.

In an embodiment of the disclosure, the method further includes: a sum of multiple spectral efficiencies is calculated, in which the spectral efficiencies respectively correspond to multiple baseband data stream signals of the first UE; and in response to the sum reaching a preset value, an update of multiple MCS respectively corresponding to the baseband data stream signals is stopped.

In an embodiment of the disclosure, the precoding information includes a digital precoder and an analog precoder of a satellite, and includes a digital precoder and an analog precoder of the first UE.

In an embodiment of the disclosure, the method further includes: at least one baseband data stream signal is allocated for each of UE, in which the UE includes the first UE, and the at least one baseband data stream signal includes the first baseband data stream signal; singular value decomposition is performed on multiple equivalent channel matrices respectively to obtain a singular value set, in which the equivalent channel matrices respectively correspond to the UE; multiple maximum singular values respectively corresponding to the equivalent channel matrices are removed from the singular value set to update the singular value set; and a second baseband data stream signal is allocated for the first UE according to the updated singular value set.

In an embodiment of the disclosure, the step of allocating the second baseband data stream signal for the first UE according to the updated singular value set includes: multiple maximum singular values respectively corresponding to the UE are selected from the updated singular value set; whether a first singular value corresponding to the first UE is determined to be the smallest among the selected maximum singular values; in response to determining that the first singular value is the smallest, the second baseband data stream signal is allocated for the first UE; and the first singular value is removed from the singular value set to update the singular value set.

In an embodiment of the disclosure, the method further includes: the number of baseband data streams n_{s,u} allocated to the first UE is determined according to the singular value set, where n_{s,u} is a positive integer; an equivalent channel matrix is calculated according to the analog precoder of the first UE and the first channel matrix; singular value decomposition is performed on the equivalent channel matrix to obtain the first n_{s,u} right singular vectors; and the analog precoder of the satellite is generated according to the first n_{s,u} right singular vectors.

In an embodiment of the disclosure, the method further includes: singular value decomposition is performed on the first channel matrix to obtain the first N_{rRF} left singular vectors, where N_{rRF} is a positive integer; and the analog precoder of the first UE is generated according to the first N_{rRF} left singular vectors.

In an embodiment of the disclosure, the precoding information includes the analog precoder of the satellite and the analog precoder of the first UE, and the method further includes: a first equivalent channel matrix is calculated according to the first channel, the analog precoder of the satellite, and the analog precoder of the first UE; singular value decomposition is performed on the equivalent channel matrix to obtain the first n_{s,u} left singular vectors, where n_{s,u} is the number of baseband data stream signals allocated to the first UE, and n_{s,u} is a positive integer; and a digital precoder of second UE is generated according to the first n_{s,u} left singular vectors.

In an embodiment of the disclosure, the step of generating the digital precoder of the second UE according to the first n_{s,u} left singular vectors includes: a second equivalent channel matrix is generated according to the first n_{s,u} left singular vectors and the first equivalent channel matrix; a third equivalent channel matrix is generated, in which the third equivalent channel matrix includes multiple equivalent channel matrices different from a fourth equivalent channel matrix, and the fourth equivalent channel matrix corresponds to the second UE; singular value decomposition is performed on the third equivalent channel matrix to obtain the last (N_{tRF}−rank( [symbol] )) right singular vectors, where N_{tRF} is the number of radio frequency chains (RF chains) of the satellite, and rank( [symbol] ) is the rank of the third equivalent channel matrix; a fifth equivalent channel matrix is generated according to the last (N_{tRF}−rank( [symbol] )) right singular vectors and the second equivalent channel matrix; the singular value decomposition is performed on the fifth equivalent channel matrix to obtain the first n_{s,u} second left singular vectors, where n_{s,u} is the number of baseband data stream signals allocated to the first UE, and n_{s,u} is a positive integer; and the digital precoder of the second UE is generated according to the first n_{s,u} left singular vectors and the first n_{s,u} second left singular vectors.

In an embodiment of the disclosure, the method further includes: singular value decomposition is performed on the fifth equivalent channel matrix to obtain the first n_{s,u} right singular vectors; and the digital precoder of the satellite is generated according to the last (N_{tRF}−rank( [symbol] )) right singular vectors and the first n_{s,u} right singular vectors.

A wireless communication device of configuring a radio resource in satellite communication disclosed in the disclosure includes a processor, a digital precoding circuit, multiple radio frequency chains (RF chains), and an analog precoding circuit. The digital precoding circuit is coupled to the processor. The RF chains are coupled to the digital precoding circuit. The analog precoding circuit is coupled to the RF chains, and the processor is configured to execute: obtaining precoding information for hybrid beamforming and a first channel matrix corresponding to a first user equipment (UE); calculating a first channel matrix gain and a first noise gain according to the precoding information and the first channel matrix; obtaining a lookup table, in which the lookup table includes mapping relationships among a modulation coding scheme (MCS), a spectral efficiency, and a required signal-to-noise ratio (SNR); calculating a first power change for increasing a first spectral efficiency of a first baseband data stream signal of the first UE and a second power change for increasing a second spectral efficiency of a second baseband data stream signal of the first UE according to the first channel matrix gain, the first noise gain, and the lookup table; and in response to the first power change being less than the second power change, updating a first MCS corresponding to the first baseband data stream signal of the first UE.

In an embodiment of the disclosure, the wireless communication device includes one of the satellite and the first UE.

Based on the above, the disclosure may minimize the transmission power of the satellite communication system while satisfying the quality of service (QoS) requirements of each of the UE.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 illustrates a schematic diagram of a satellite communication system according to an embodiment of the disclosure.

FIG. 2 illustrates a flowchart of a method of configuring a radio resource in satellite communication according to an embodiment of the disclosure.

FIG. 3 illustrates a schematic diagram of an algorithm for generating an analog precoder and the number of baseband data stream signals according to an embodiment of the disclosure.

FIG. 4 illustrates a schematic diagram of a singular value set according to an embodiment of the disclosure.

FIG. 5 illustrates a schematic diagram of an algorithm for generating a digital precoder according to an embodiment of the disclosure.

FIG. 6 illustrates a schematic diagram of an algorithm for configuring a modulation coding scheme according to an embodiment of the disclosure.

FIG. 7 illustrates simulation results of wireless communication performance according to an embodiment of the disclosure.

FIG. 8 illustrates a flowchart of a method of configuring a radio resource in satellite communication according to an embodiment of the disclosure.

### DETAILED DESCRIPTION OF DISCLOSURED EMBODIMENTS

In order to reduce the total transmission power of a satellite serving multiple user equipments (UE) or UT, multiple data streams may be used for communication between one UE and the satellite. Since the number of data streams that can be supported by the satellite is limited, a satellite communication system needs to determine how to allocate the number of data streams to each of the UE and configure appropriate modulation coding schemes (MCS) for the data streams. If the resources of data streams can be properly allocated, the total transmission power of the satellite can be significantly reduced. The disclosure may configure one or more baseband data streams for UE and configure the appropriate MCS for each of baseband data streams, thereby reducing the total transmission power of the satellite. Experiments show that the method of the disclosure may reduce the total transmission power of the satellite by approximately 20%.

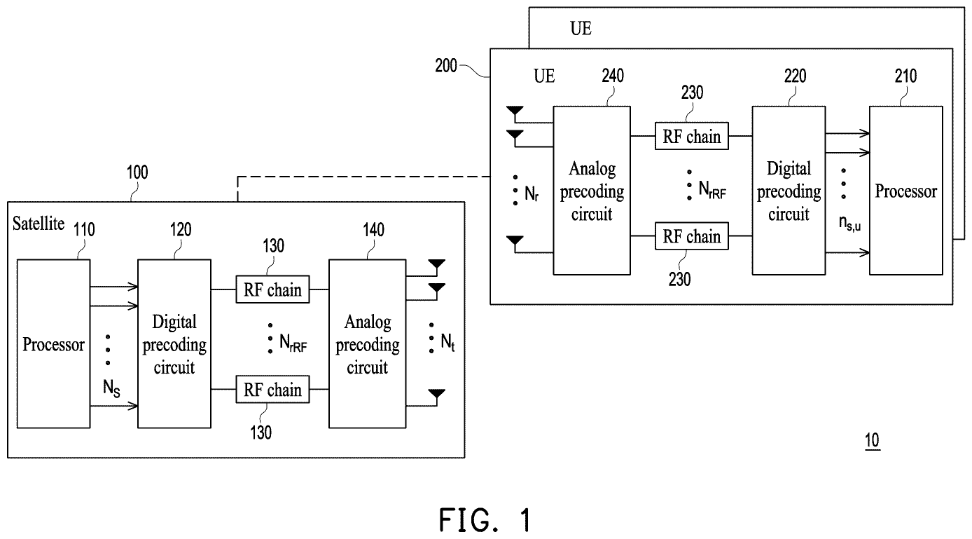

FIG. 1 illustrates a schematic diagram of a satellite communication system 10 according to an embodiment of the disclosure. The satellite communication system 10 may include a satellite 100 and one or more UE (or UT) 200 served by the satellite 100, in which the satellite 100 may be in communication connection with the UE 200. The satellite 100 or UE 200 has a hardware structure that may be used to implement hybrid beamforming.

The satellite 100 may include a processor 110, a digital precoding circuit 120, N_{tRF} radio frequency chains (RF chains) 130, and an analog precoding circuit 140.

The processor 110 may be, for example, a communication chip, a central processing unit (CPU), or other programmable general-purpose or special-purpose micro control units (MCUs), microprocessors, digital signal processors (DSPs), programmable controllers, or application specific integrated circuits (ASICs). The processor 110 may be coupled to the digital precoding circuit 120, and transmit N_{S} baseband data streams to the digital precoding circuit 120 or receive N_{S} baseband data streams from the digital precoding circuit 120. N_{S}=n_{s,1}+n_{s,2}+ . . . +n_{s,U}, where U is the total number of the UE 200, and n_{s,u} is the number of baseband data streams allocated to the u-th UE 200, where n_{s,u} is a positive integer.

The digital precoding circuit 120 may be used to implement the function of a digital precoder, and may convert N_{S} baseband data stream signals and N_{tRF} digital baseband signals to and from each other (for example, converting N_{S} baseband data stream signals into N_{tRF} digital baseband signals), where N_{S}≤N_{tRF}, and N_{tRF} is a positive integer. The digital precoding circuit 120 may be coupled to N_{tRF} RF chains 130, and transmit N_{tRF} digital baseband signals to N_{tRF} RF chains 130 or receive N_{tRF} digital baseband signals from N_{tRF} RF chains 130.

The RF chain 130 may include elements such as a digital-to-analog converter, an analog-to-digital converter, a mixer, a filter, or a power amplifier. The RF chain 130 may convert N_{tRF} digital baseband signals and N_{tRF} radio frequency signals to and from each other.

The analog precoding circuit 140 may be coupled to N_{tRF} RF chains 130. The analog precoding circuit 140 may include, for example, a phased array antenna with Nₜ antenna units, where N_{S}≤N_{tRF}<<Nₜ. The analog precoding circuit 140 may be used to implement the function of an analog precoder, and may convert N_{tRF} radio frequency signals and Nₜ radio frequency signals to and from each other (for example, converting N_{tRF} radio frequency signals into Nₜ radio frequency signals). In an embodiment, the phased array antenna may be a uniform linear array (ULA) antenna, and Nₜ antenna units are equally spaced and arranged in a straight line. In an embodiment, the phased array antenna may be a uniform planar array (UPA) antenna, and Nₜ antenna units are equally spaced and arranged in a plane.

The UE 200 may include a processor 210, a digital precoding circuit 220, N_{rRF} RF chains 230, and an analog precoding circuit 240.

The processor 210 may be, for example, a communication chip, CPU, or other programmable general-purpose or special-purpose MCUs, microprocessors, DSPs, programmable controllers, or ASICs. The processor 210 may be coupled to the digital precoding circuit 220, and transmit n_{s,u} baseband data stream signals to the digital precoding circuit 220 or receive n_{s,u} baseband data stream signals from the digital precoding circuit 220, where n_{s,u} represents the number of baseband data streams corresponding to the u-th UE 200, and n_{s,u} is a positive integer.

The digital precoding circuit 220 may be used to implement the function of a digital precoder, and may convert n_{s,u} baseband data stream signals and N_{rRF} digital baseband signals to and from each other (for example, converting N_{rRF} digital baseband signals into n_{s,u} baseband data stream signals), where n_{s,u}≤N_{rRF}, and N_{rRF} is a positive integer. The digital precoding circuit 220 may be coupled to N_{rRF} RF chains 230, and transmit N_{rRF} digital baseband signals to N_{rRF} RF chains 230 or receive N_{rRF} digital baseband signals from N_{rRF} RF chains 230.

The RF chain 230 may include elements such as a digital-to-analog converter, an analog-to-digital converter, a mixer, a filter, or a power amplifier. The RF chain 230 may convert N_{rRF} digital baseband signals and N_{rRF} radio frequency signals to and from each other.

The analog precoding circuit 240 may be coupled to N_{rRF} RF chains 230. The analog precoding circuit 240 may include, for example, a phased array antenna with Nᵣ antenna units, where n_{s,u}≤N_{rRF}<<Nᵣ. The analog precoding circuit 240 may be used to implement the function of an analog precoder, and may convert N_{rRF} radio frequency signals and Nᵣ radio frequency signals to and from each other (for example, converting N_{rRF} radio frequency signals into Nᵣ radio frequency signals).

The wireless communication device of the disclosure may configure the digital precoding circuit 120, analog precoding circuit 140, digital precoding circuit 220, or analog precoding circuit 240 as appropriate precoders to eliminate inter-interference between the UE 200 and intra-interference between the baseband data streams. The wireless communication device may allocate the number of baseband data streams for each of the UE and may configure an appropriate MCS for each of the baseband data streams to reduce the total transmission power of the satellite 100. The aforementioned wireless communication device may include, but is not limited to, the satellite 100 or UE 200. For example, in addition to the satellite 100 and UE 200, the satellite communication system 10 may include other computing devices for executing the method of the disclosure. Table 1 shows the notations used in the embodiments of the disclosure.

TABLE 1

| | |
|---|---|
| Nₜ | Number of antennas of satellite 100, where Nₜ » |
| | N_{tRF} ≥ N_{S} |
| N_{tRF} | Number of RF chains 130 of satellite 100 |
| N_{S} | Total number of baseband data stream signals of |
| | satellite 100, where N_{S} = n_{s,1} + n_{s,2} + · · · + n_{s,U} |
| U | Number of UE 200 served by satellite 100 |
| Nᵣ | Number of antennas of UE 200, where Nᵣ » |
| | N_{rRF} ≥ n_{s,u} |
| n_{s,u} | Number of baseband data stream signals of the |
| | u-th UE 200 |
| W_{RFu} ∈ [symbol] | Analog precoder of the u-th UE 200 |
| W_{BBu} ∈ [symbol] | Digital precoder of the u-th UE 200 |
| F_{RF} ∈ [symbol] | Analog precoder of satellite 100 |
| F_{BB} ∈ [symbol] | Digital precoder of satellite 100 |
| Hᵤ ∈ [symbol] | Channel matrix between the u-th UE 200 and |
| | satellite 100 |
| Zᵤ ∈ [symbol] | Complex additive white Gaussian noise (AWGN) |
| | $with power {σ}_{n}^{2}$ |

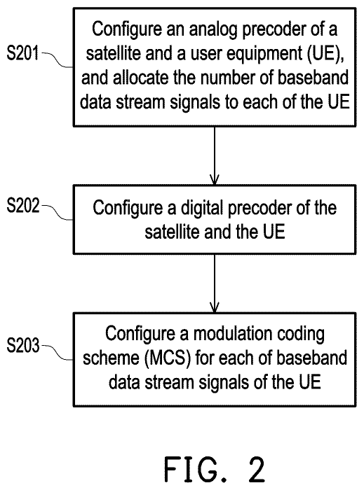

FIG. 2 illustrates a flowchart of a method of configuring a radio resource in satellite communication according to an embodiment of the disclosure, in which the method may be implemented by the wireless communication device of the disclosure.

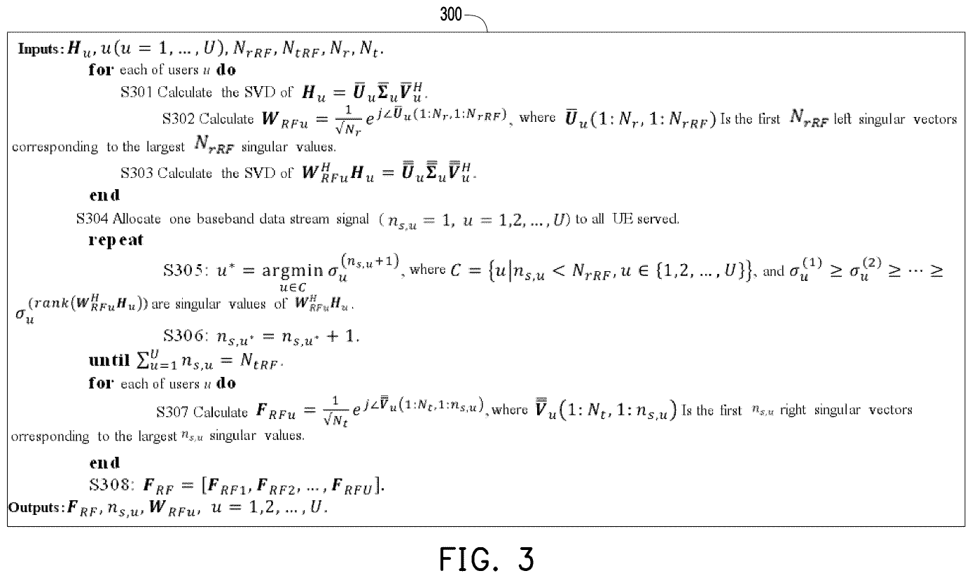

In step S201, the wireless communication device may configure an analog precoder F_{RF} of the satellite 100 and an analog precoder W_{RFu} of a user u corresponding to the u-th UE 200 (or referred to as the user u) according to a channel matrix Hᵤ, without considering noise or interference, and allocate the number of baseband data stream signals n_{s,u} for each of the UE 200. The wireless communication device may execute an algorithm 300 as shown in FIG. 3 to complete step S201.

In step S202, the wireless communication device may configure a digital precoder F_{BB} of the satellite 100 and a digital precoder W_{BBu} of the user u according to parameters such as the channel matrix Hᵤ, the analog precoder W_{RFu}, and the number of baseband data stream signals n_{s,u}, to eliminate inter-interference between the UE 200 and intra-interference between the baseband data stream signals.

In step S203, the wireless communication device may configure the MCS for each of baseband data stream signals of the user u to reduce the total transmission power of the satellite 100. In an embodiment, the wireless communication device may obtain and store a lookup table, and configure the MCS for the baseband data stream according to the lookup table, and the lookup table may include mapping relationships among the MCS and an index thereof, a spectral efficiency, and a required signal-to-noise ratio (SNR). Table 2 is an example of the lookup table. The types of MCS may include, but are not limited to, quaternary phase shift keying (QPSK) modulation, 8 phase shift keying (8PSK) modulation, 16APSK or 32APSK, where r represents the coding rate. When the value of the MCS index increases, it indicates that the spectral efficiency of the MCS increases, and also indicates that the required SNR to achieve the expected frame error rate (FER) using the MCS increases.

TABLE 2

| | | Spectral | |
|---|---|---|---|
| MCS | | efficiency | Required SNR |
| index | MCS | (bps/Hz) | at FER = 10⁻⁵ |
| 1 | QPSK, r = 1/4 | 0.5 | −2.19 |
| 2 | QPSK, r = 2/5 | 0.8 | −0.22 |
| 3 | QPSK, r = 1/2 | 1 | 1.12 |
| 4 | QPSK, r = 2/3 | 1.33 | 3.26 |
| 5 | QPSK, r = 4/5 | 1.6 | 4.81 |
| 6 | 8PSK, r = 2/3 | 2 | 6.76 |
| 7 | 8PSK, r = 5/6 | 2.5 | 9.57 |
| 8 | 16APSK, r = 3/4 | 3.0 | 10.43 |
| 9 | 16APSK, r = 5/6 | 3.33 | 11.86 |
| 10 | 32APSK, r = 3/4 | 3.75 | 13.11 |

FIG. 3 illustrates a schematic diagram of the algorithm 300 for generating an analog precoder and the number of baseband data stream signals according to an embodiment of the disclosure. Before executing the algorithm 300, the wireless communication device may obtain information such as the number of antennas Nₜ of the satellite 100, the number of antennas Nᵣ of the user u, the number of RF chains N_{tRF} of the satellite 100, and the number of RF chains N_{rRF} of the user u. The wireless communication device may also measure or obtain the channel matrix Hᵤ between the user u and the satellite 100. Next, the wireless communication device may iteratively execute step S301 to step S303 to generate the analog precoder W_{RFu} for each of the users u, and may perform singular value decomposition of

$${W}_{RFu}^{H} {H}_{u}$$

for each of the users u.

Specifically, in step S301, the wireless communication device may perform singular value decomposition the (SVD) on the channel matrix Hᵤ of the user u:

$${H}_{u} = {\overline{U}}_{u} {\overline{Σ}}_{u} {\overline{V}}_{u}^{H} ,$$

where u=1, 2, . . . , U, Ūᵤ is the matrix of left singular vectors, Σ̅ᵤ is the diagonal matrix, and Vᵤ is the matrix of right singular vectors.

In step S302, the wireless communication device may generate the analog precoder (or analog combiner)

$${W}_{R F u} = \frac{1}{√ {N}_{r}} {e}^{j ∠ {\overline{U}}_{u} ( 1 : {N}_{r} , 1 : {N}_{r R F} )}$$

for the user u, where 1:Nᵣ indicates the first to Nᵣ th rows of the matrix Ūᵤ, 1:N_{rRF} indicates the first to N_{rRF} th columns of the matrix Ūᵤ, and Ūᵤ(1:Nᵣ, 1:N_{rRF}) represents the first N_{rRF} left singular vectors corresponding to the largest N_{rRF} singular values.

In step S303, the wireless communication device may generate an equivalent channel matrix

$${W}_{R F u}^{H} {H}_{u}$$

∈ [symbol] based on the analog precoder W_{RFu} and the channel matrix Hᵤ, and perform singular value decomposition on

$${W}_{R F u}^{H} {H}_{u} : {W}_{R F u}^{H} {H}_{u} = {{U}^{\overline{\_}}}_{u} {{Σ}^{\overline{\_}}}_{u} {{U}^{\overline{\_}}}_{u}^{H} ,$$

where U̅ᵤ is the matrix of left singular vectors, Σ̅ᵤ is the diagonal matrix, and V̅ᵤ is the matrix of right singular vectors.

After completing the singular value decomposition of step S303 for each of the users u (i.e., U users), the wireless communication device may obtain a singular value set corresponding to the equivalent channel matrix

$${W}_{R F u}^{H} {H}_{u}$$

(for example, a set of diagonal elements of Σ̅ᵤ), where the singular value set may include all singular values

$${σ}_{u}^{( i )}$$

of each of the users, where i=1, 2, . . . , rank

$$( {W}_{RFu}^{H} {H}_{u} )$$

is the index of singular values, u=1, 2, . . . , U is the index of users, and rank

$$( {W}_{RFu}^{H} {H}_{U} )$$

is the rank of the equivalent channel matrix

$${W}_{R F u}^{H} {H}_{u} ,$$

where

$${σ}_{u}^{( 1 )} \geq {σ}_{u}^{( 2 )} \geq ⋯ \geq {σ}_{u}^{( rank ( {W}_{RFu}^{H} {H}_{u} ) )} .$$

For example, assuming the number of users U=4, the number of RF chains N_{tRF}=7 for the satellite 100, and the number of RF chains N_{rRF}=3 for each of the users. After completing step S301 for the first user, the wireless communication device may obtain the singular values

$${σ}_{1}^{( 1 )} , {σ}_{1}^{( 2 )} , and {σ}_{1}^{( 3 )}$$

of the first user, where

$${σ}_{1}^{( 1 )} , {σ}_{1}^{( 2 )} , and {σ}_{1}^{( 3 )}$$

are the diagonal elements of the diagonal matrix Σ̅₁. In a similar manner, the wireless communication device may obtain the singular values

$${σ}_{2}^{( 1 )} , {σ}_{2}^{( 2 )} , and {σ}_{2}^{( 3 )}$$

of the second user, the singular values

$${σ}_{3}^{( 1 )} , {σ}_{3}^{( 2 )} , and {σ}_{3}^{( 3 )}$$

of the third user, and the singular values

$${σ}_{4}^{( 1 )} , {σ}_{4}^{( 2 )} , and {σ}_{4}^{( 3 )}$$

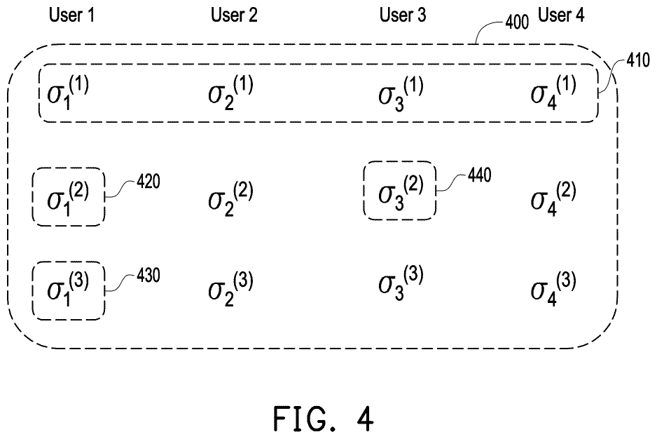

of the fourth user, thereby obtaining a singular value set 400 as shown in FIG. 4.

In step S304, the wireless communication device may allocate one baseband data stream signal (n_{s,u}=1, u=1, 2, . . . , U) to each of the users to ensure that each of the users can be served by the satellite 100, where n_{s,u} is the number of baseband data stream signals allocated to the user u. For each of the users u or each of the channel matrices Hᵤ, the wireless communication device may remove the maximum singular value

$${σ}_{j}^{( 1 )} ( j = 1 , 2 , … , U )$$

corresponding to the channel matrix Hᵤ from the singular value set to update the singular value set. In subsequent steps, the wireless communication device may allocate one or more additional baseband data stream signals to one or more users according to the updated singular value set.

Taking FIG. 4 as an example, the wireless communication device may allocate one baseband data stream signal (n_{s,1}=1, n_{s,2}=1, n_{s,3}=1, n_{s,4}=1) to each of users 1 to 4, and may remove a singular value subset 410 from the singular value set 400, in which the singular value subset 410 may include the maximum singular value

$${σ}_{1}^{( 1 )}$$

of the user 1, the maximum singular value

$${σ}_{2}^{( 1 )}$$

of the user 2, the maximum singular value

$${σ}_{3}^{( 1 )}$$

of the user 3, and the maximum singular value

$${σ}_{4}^{( 1 )}$$

of the user 4.

In step S305, the wireless communication device may select multiple maximum singular values corresponding to multiple users from the updated singular value set, and determine whether a singular value

$${σ}_{u}^{( {n}_{s , {u}^{*}} + 1 )}$$

corresponding to a user u* is the smallest among the selected maximum singular values. If the singular value

$${σ}_{u}^{( {n}_{s , {u}^{*}} + 1 )}$$

is the smallest among the selected maximum singular values, the wireless communication device may select the user u*, as shown in equation (1), where the number of baseband data stream signals n_{s,u*} currently allocated to the user u* needs to be less than N_{rRF}, and

$${σ}_{u}^{( 1 )} \geq {σ}_{u}^{( 2 )} \geq ⋯ \geq {σ}_{u}^{( rank ( {W}_{RFu}^{H} {H}_{u} ) )}$$

values of the equivalent channel matrix

$${W}_{RFu}^{H} {H}_{u} .$$

$$u *= {argmin}_{∈ uC} {σ}_{u}^{( {n}_{s , u} + 1 )} , C = \{ u \vert {n}_{s , u} < {N}_{rRF} , u ∈ \{ 1 , 2 , … , U \} \} \qquad ( 1 )$$

In step S306, the wireless communication device may allocate an additional baseband data stream signal (n_{s,u*}=n_{s,u*}+1) to the selected user (i.e., the user u*), and may remove the singular value

$${σ}_{u}^{( {n}_{s , u} * + 1 )}$$

corresponding to the additional baseband data stream signal from the singular value set to update the singular value set.

The wireless communication device may repeatedly execute steps S305 to S306 to allocate additional baseband data stream signals to each of the users until the number of allocated baseband data stream signals reaches the upper limit N_{tRF} of the number of baseband data stream signals that can be provided by the satellite

$$100 ( {\sum }_{u = 1}^{U} {n}_{s , u} = {N}_{tRF} ) .$$

in other words, the wireless communication device may determine the number of baseband data stream signals n_{s,u} allocated to the user u according to the singular value set. Users with poorer channel quality may be allocated more baseband data stream signals to ensure that the quality of service for the users meets the user requirements.

Taking FIG. 4 as an example, after removing the singular value subset 410 from the singular value set 400, the wireless communication device may select multiple maximum singular values

$${σ}_{1}^{( 2 )} , {σ}_{2}^{( 2 )} , {σ}_{3}^{( 2 )} , and {σ}_{4}^{( 2 )}$$

corresponding to the user 1, the user 2, the user 3, and the user 4, respectively, from the updated singular value set 400. It is worth noting that since the singular values

$${σ}_{1}^{( 1 )} , {σ}_{2}^{( 1 )} , {σ}_{3}^{( 1 )} , and {σ}_{4}^{( 1 )}$$

have all been removed from the singular value set 400, the current maximum singular values in the singular value set 400 corresponding to the user 1, the user 2, the user 3, and the user 4 are

$${σ}_{1}^{( 2 )} , {σ}_{2}^{( 2 )} , {σ}_{3}^{( 2 )} , and {σ}_{4}^{( 2 )} ,$$

respectively. The wireless communication device may select the smallest one from the selected maximum singular values. If the singular value

$${σ}_{1}^{( 2 )}$$

of the user 1 is the smallest singular value 420 among

$$\{ \begin{matrix}{σ}_{1}^{( 2 )} & {σ}_{2}^{( 2 )} & {σ}_{3}^{( 2 )} & {σ}_{4}^{( 2 )}\end{matrix} \} ,$$

the wireless communication device may allocate an additional baseband data stream signal (n_{s,1}=2, n_{s,2}=1, n_{s,3}=1,n_{s,4}=1) to the user 1, and may remove the singular value 420 from the singular value set 400 to update the singular value set 400.

After removing the singular value subset 410 and the singular value 420 from the singular value set 400, the wireless communication device may select multiple maximum singular values

$${σ}_{1}^{( 3 )} , {σ}_{2}^{( 2 )} , {σ}_{3}^{( 2 )} , and {σ}_{4}^{( 2 )}$$

corresponding to the user 1, the user 2, the user 3, and the user 4, respectively, from the updated singular value set 400. It is worth noting that since the singular values

$${σ}_{1}^{( 1 )} and {σ}_{1}^{( 2 )}$$

of the user 1 have both been removed from the singular value set 400, the current maximum singular value corresponding to the user 1 in the singular value set 400 is

$${σ}_{1}^{( 3 )} .$$

The wireless communication device may select the smallest one from the selected maximum singular values. If the singular value

$${σ}_{1}^{( 3 )}$$

of the user 1 is the smallest singular value 430 among

$$\{ \begin{matrix}{σ}_{1}^{( 3 )} & {σ}_{2}^{( 2 )} & {σ}_{3}^{( 2 )} & {σ}_{4}^{( 2 )}\end{matrix} \} ,$$

the wireless communication device may allocate an additional baseband data stream signal (n_{s,1}=3, n_{s,2}=1, n_{s,3}=1, n_{s,4}=1) to the user 1, and may remove the singular value 430 from the singular value set 400 to update the singular value set 400.

After removing the singular value subset 410, the singular value 420, and the singular value 430 from the singular value set 400, the wireless communication device may select multiple maximum singular values

$${σ}_{2}^{( 2 )} , {σ}_{3}^{( 2 )} , and {σ}_{4}^{( 2 )}$$

corresponding to the user 2, the user 3, and the user 4, respectively, from the updated singular value set 400. The wireless communication device may select the smallest one from the selected maximum singular values. If the singular value

$${σ}_{3}^{( 2 )}$$

of the user 3 is the smallest singular value 440 among

$$\{ {σ}_{2}^{( 2 )} {σ}_{3}^{( 2 )} {σ}_{4}^{( 2 )} \} ,$$

the wireless communication device may allocate an additional baseband data stream signal (n_{s,1}=3, n_{s,2}=1, n_{s,3}=2,n_{s,4}=1) to the user 3, and may remove the singular value 440 from the singular value set 400 to update the singular value set 400. After the number of allocated baseband data stream signals reaches N_{tRF}=7, the wireless communication device may stop executing steps S305 and S306, and then execute step S307.

In step S307, the wireless communication device may generate an analog precoding matrix

$${F}_{RFu} = \frac{1}{√ {N}_{t}} {e}^{j ∠ {\overline{\overline{V}}}_{u} ( 1 : {N}_{t} , 1 : {n}_{s , u} )}$$

for the user u of the satellite 100, where 1:Nₜ indicates the first to the Nₜ th columns of a matrix V̅ᵤ, 1:n_{s,u} indicates the first to the n_{s,u} th rows of the matrix V̅ᵤ, and V̅ᵤ (1:Nₜ, 1:n_{s,u}) represents the first n_{s,u} right singular vectors corresponding to the largest n_{s,u} singular values.

After generating U analog precoding matrices F_{RF1} to F_{RFU} for users 1 to U, respectively, for the satellite 100, in step S308, the wireless communication device may combine U analog precoding matrices into an analog precoder F_{RF}=[F_{RF1}, F_{RF2}, . . . , F_{RFU}] for the satellite 100.

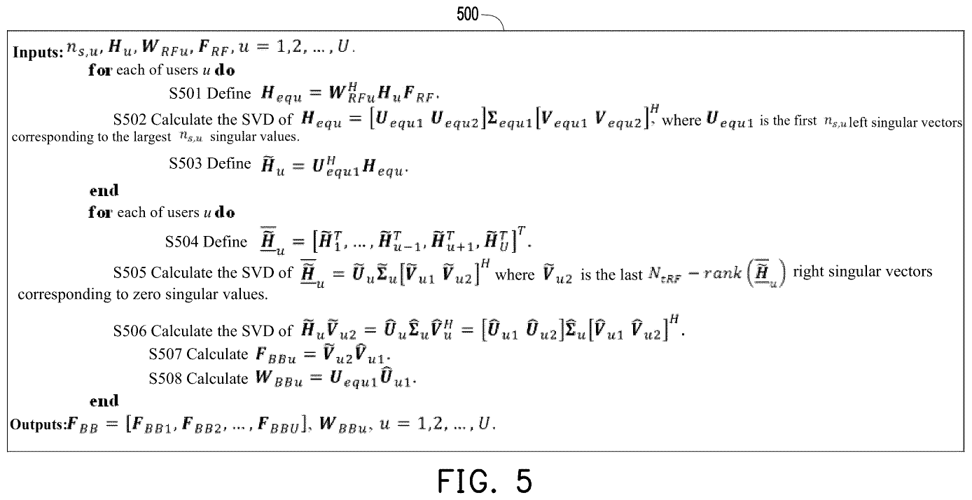

FIG. 5 illustrates a schematic diagram of an algorithm 500 for generating a digital precoder according to an embodiment of the disclosure. Before executing the algorithm 500, the wireless communication device may obtain a channel matrix Hᵤ corresponding to a user u (u=1, 2, . . . , U), the number of baseband data stream signals n_{s,u}, and an analog precoder W_{RFu}, and may obtain an analog precoder F_{RF} of the satellite 100. The wireless communication device may iteratively execute steps S501 to S503 to generate an equivalent channel matrix \tilde{H}ᵤ for each of the users. In an embodiment, the analog precoder W_{RFu} or the analog precoder F_{RF} may be different from the analog precoder generated according to the algorithm 300.

Specifically, in step S501, the wireless communication device may generate an equivalent channel matrix

$${H}_{equ} = {W}_{RFu}^{H} {H}_{u} {F}_{RF}$$

according to the analog precoder W_{RFu}, the channel matrix Hᵤ, and the analog precoder F_{RF}.

In step S502, the wireless communication device may perform singular value decomposition H_{equ}=[U_{equ1} U_{equ2}]Σ_{equ1}[V_{equ1} V_{equ2}]^{H} on the equivalent channel matrix H_{equ}, where Σ_{equ1} is the diagonal matrix, U_{equ1} represents the first n_{s,u} left singular vectors corresponding to the largest n_{s,u} singular values, U_{equ2} represents the last (N_{rRF}−n_{s,u}) left singular vectors corresponding to zero singular values, Σ_{equ1} is the diagonal matrix, V_{equ1} represents the first n_{s,u} right singular vectors corresponding to the largest n_{s,u} singular values, and V_{equ2} represents the last (N_{tRF}−n_{s,u}) right singular vectors corresponding to zero singular values. U_{equ1} may be used to generate the digital precoder for the user u and other users (i.e., other users served by the satellite 100, such as user (u−1)).

In step S503, the wireless communication device may generate an equivalent channel matrix

$${\tilde{H}}_{u} = {U}_{equ 1}^{H} {H}_{equ}$$

corresponding to the user u according to the matrix U_{equ1} and the equivalent channel matrix H_{equ}, in which the equivalent channel matrix \tilde{H}ᵤ may be used to generate the digital precoder for the user u and other users (i.e., other users served by the satellite 100).

After obtaining the equivalent channel matrix \tilde{H}ᵤ for each of the users, the wireless communication device may iteratively execute steps S504 to S508 to generate a digital precoder W_{BBu} for each of the users, and generate a digital precoding matrix F_{BBu} for the u-th user for the satellite.

In step S504, the wireless communication device may define an equivalent channel matrix

$${\underline{\overline{\tilde{H}}}}_{u} = {[ {\tilde{H}}_{1}^{T} , ... , {\tilde{H}}_{u - 1}^{T} , {\tilde{H}}_{u + 1}^{T} , {\tilde{H}}_{U}^{T} ]}^{T}$$

for the user u. According to the above equation, the equivalent channel matrix [symbol] of the user u is related to multiple equivalent channel matrices \tilde{H}ᵤ′ (u′≠u, i.e., \tilde{H}_{u′} is different from \tilde{H}ᵤ) of multiple other users served by the satellite 100, and the equivalent channel matrix [symbol] of the user u may not include the equivalent channel matrix \tilde{H}ᵤ of the user u. For example, assuming there are 4 users (i.e., U=4), the equivalent channel matrix [symbol] =[\tilde{H}₁ \tilde{H}₂ \tilde{H}₄] corresponding to the third user may include the equivalent channel matrix \tilde{H}₁ corresponding to the first user, the equivalent channel matrix \tilde{H}₂ corresponding to the second user, and the equivalent channel matrix \tilde{H}₄ corresponding to the fourth user, without including the equivalent channel matrix \tilde{H}₃ corresponding to the third user.

In step S505, the wireless communication device performs singular value decomposition [symbol] =Ũᵤ\tilde{Σ}ᵤ[\tilde{V}ᵤ\tilde{V}ᵤ₂]^{H} on the equivalent channel matrix [symbol] , where Ũᵤ is the matrix of left singular vectors, \tilde{Σ}ᵤ is the diagonal matrix, \tilde{V}ᵤ₁ represents the first (rank( [symbol] )) right singular vectors corresponding to the largest (rank ( [symbol] )) singular values, and \tilde{V}ᵤ₂ represents the last (N_{tRF}−rank ( [symbol] )) right singular vectors corresponding to zero singular values, where rank ( [symbol] ) is the rank of the equivalent channel matrix [symbol] .

In step S506, the wireless communication device may generate an equivalent channel matrix \tilde{H}ᵤ\tilde{V}ᵤ₂ according to the matrix \tilde{V}ᵤ₂ and the equivalent channel matrix \tilde{H}ᵤ, and perform singular value decomposition

$${\tilde{H}}_{u} {\tilde{V}}_{u 2} = {\hat{U}}_{u} {\hat{\sum }}_{u} {\hat{V}}_{u}^{H} = [ \begin{matrix}{\hat{U}}_{u 1} & {\hat{U}}_{u 2}\end{matrix} ] {\hat{\sum }}_{u} {[ \begin{matrix}{\hat{V}}_{u 1} & {\hat{V}}_{u 2}\end{matrix} ]}^{H}$$

on the equivalent channel matrix \tilde{H}ᵤ\tilde{V}ᵤ₂, where Ûᵤ₁ represents the first (rank(\tilde{H}ᵤ\tilde{V}ᵤ₂)) left singular vectors corresponding to the largest (rank(\tilde{H}ᵤ\tilde{V}ᵤ₂)) singular values (or the first n_{s,u} left singular vectors corresponding to the largest n_{s,u} singular values), Ûᵤ₂ represents the last (n_{s,u}−rank(\tilde{H}ᵤ\tilde{V}ᵤ₂)) left singular vectors corresponding to (n_{s,u}−rank(\tilde{H}ᵤ\tilde{V}ᵤ₂)) singular values, \hat{Σ}ᵤ represents the diagonal matrix, \hat{V}ᵤ₁ represents the first (rank(\tilde{H}ᵤ\tilde{V}ᵤ₂)) right singular vectors corresponding to the largest (rank(\tilde{H}ᵤ\tilde{V}ᵤ₂)) singular values (or the first n_{s,u} right singular vectors corresponding to the largest n_{s,u} singular values), and \hat{V}ᵤ₂ represents the last (N_{tRF}−rank( [symbol] )−rank(\tilde{H}\tilde{V}ᵤ₂)) right singular vectors corresponding to (N_{tRF}−rank( [symbol] )−rank(\tilde{H}ᵤ\tilde{V}ᵤ₂)) zero singular values, where rank(\tilde{H}ᵤ\tilde{V}ᵤ₂) is the rank of the equivalent channel matrix \tilde{H}ᵤ\tilde{V}ᵤ₂.

In step S507, the wireless communication device may generate a digital precoding matrix F_{BBu}=\tilde{V}ᵤ₂\hat{V}ᵤ₁ for the satellite 100 for the user u according to the matrices \tilde{V}ᵤ₂ and \hat{V}ᵤ₁. The digital precoding matrix F_{BBu} may be used to compose the digital precoder F_{BB}=[F_{BB1}, F_{BB2}, . . . , F_{BBU}] of the satellite 100.

In step S508, the wireless communication device may generate a digital precoder W_{BBu}=U_{equ1} Ûᵤ₁ for the user u according to the matrix Ûᵤ₁ and the equivalent channel matrix U_{equ1}.

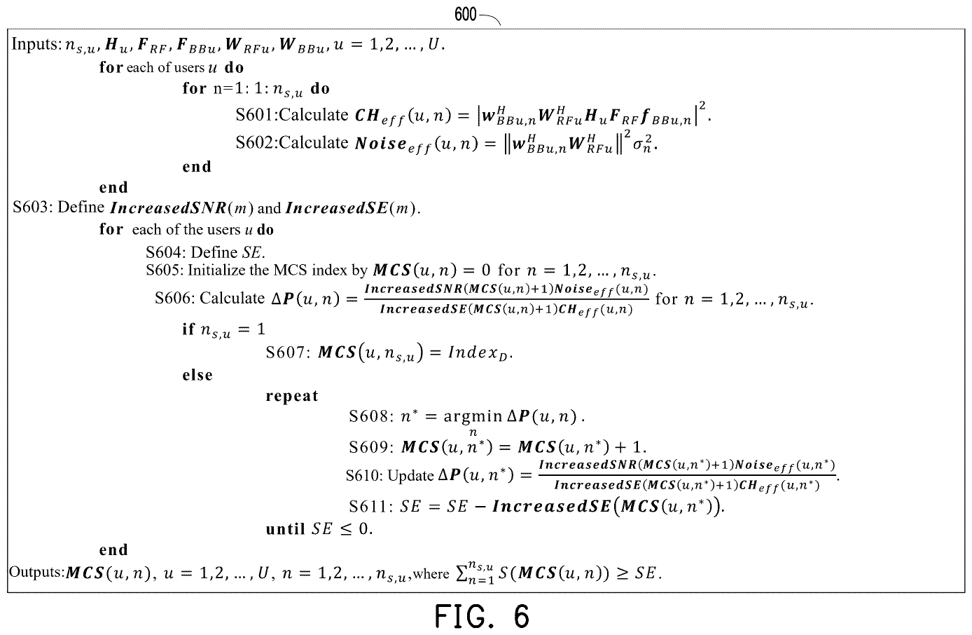

FIG. 6 illustrates a schematic diagram of an algorithm 600 for configuring a modulation coding scheme (MCS) according to an embodiment of the disclosure. The wireless communication device may obtain precoding information for hybrid beamforming and a channel matrix Hᵤ corresponding to a user u, in which the precoding information may include an analog precoder W_{RFu} and a digital precoder W_{BBu} for the user u, and a digital precoder F_{BB}=[F_{BB1}, F_{BB2}, . . . , F_{BBU}] and an analog precoder F_{RF} for the satellite 100. The wireless communication device may configure an MCS for the baseband data stream signal of the user u according to the precoding information and the channel matrix Hᵤ. In an embodiment, the precoder W_{RFu}, W_{BBu}, F_{RF} Or F_{BB} may be different from the precoder generated according to the algorithm 300 or algorithm 500. For example, in the embodiment of FIG. 6, the digital precoder W_{BBu} or F_{BB} may include a zero forcing precoder.

The wireless communication device may iteratively execute steps S601 to S602 to calculate a channel matrix gain and a noise gain for each of baseband data stream signals of each of users according to the precoding information and the channel matrix Hᵤ.

In step S601, the wireless communication device may calculate a channel matrix gain CH_{eff} (u,n) corresponding to the nth baseband data stream signal of the user u, as shown in equation (2), where W_{BBu,n} represents the digital precoding vector corresponding to the nth baseband data stream signal of the user u, f_{BBu,n} represents the digital precoding vector of the satellite 100 for the nth baseband data stream signal of the user u.

$${CH}_{eff} ( u , n ) = {\vert {w}_{BBu , n}^{H} {W}_{RFu}^{H} {H}_{u} {F}_{RF} {f}_{BBu , n} \vert}^{2} \qquad ( 2 )$$

In step S602, the wireless communication device may calculate a noise gain Noise_{eff}(u,n) corresponding to the nth baseband data stream signal of the user u, as shown in equation (3), where σₙ represents the standard deviation of additive white Gaussian noise (AWGN).

$${Noise}_{eff} ( u , n ) = {‖ {w}_{BBu , n}^{H} {W}_{RFu}^{H} ‖}^{2} {σ}_{n}^{2} \qquad ( 3 )$$

After calculating the channel matrix gain CH_{eff}(u,n) and the noise gain Noise_{eff}(u,n) for each of the baseband data stream signals of each of the users, in step S603, the wireless communication device may define IncreasedSNR(m) and IncreasedSE(m), in which IncreasedSNR(m) is the increased required SNR when switching the MCS of the baseband data stream from MCS (m−1) to MCS m, and IncreasedSE(m) is the increased required spectral efficiency when switching the MCS of the baseband data stream signal from MCS (m−1) to MCS m, where (m−1) or m is the index of the MCS, and m is a positive integer greater than or equal to 2. When the value of the MCS index increases, it represents an increase in the spectral efficiency of the MCS, and also represents an increase in the required SNR to achieve the expected frame error rate (FER) using the MCS.

Specifically, the wireless communication device may store a lookup table in a storage medium, and the lookup table may include mapping relationships among the MCS, the spectral efficiency, and the required signal-to-noise ratio (SNR). The wireless communication device may obtain information of IncreasedSNR(m) and IncreasedSE(m) from the lookup table. Taking the lookup table shown in Table 2 as an example, assuming m=2, the wireless communication device may calculate the difference between the spectral efficiency of MCS 2 at 0.8 bits per second/Hertz (bps/Hz) and the spectral efficiency of MCS 1 at 0.5 bps/Hz according to the lookup table to obtain IncreasedSE(2)=0.3 bps/Hz. In addition, the wireless communication device may calculate the difference between the required SNR of −0.22 decibels (dB) to achieve FER=10⁻⁵ using the MCS 2 and the required SNR of −2.19 dB to achieve FER=10⁻⁵ using the MCS 1 according to the lookup table to obtain

$$IncreasedSNR ( 2 ) = ( {10}^{\frac{- 0.22}{10}} ) - ( {10}^{\frac{- 2.19}{10}} ) = 0.9506 - 0.6039 = 0.3467 .$$

The wireless communication device iteratively executes steps S604 to S611 to configure an appropriate MCS for each of the baseband data stream signals of each of the users, thereby minimizing the total transmission power of the satellite 100 without affecting the quality of service.

In step S604, the wireless communication device may configure an initial value for a variable SE, in which SE is the preset value that the sum of spectral efficiencies of all baseband data stream signals for each of the users needs to achieve. The preset value SE may be customized by the user according to requirements. For example, the user may define SE=3.7037. SE=3.7037 represents that the sum of spectral efficiencies of all baseband data stream signals for each of the users served by the satellite 100 needs to reach 3.7037 bps/Hz.

In step S605, the wireless communication device may initialize the MCS of each of the baseband data streams for the user u, setting the index MCS(u,n)=0. In other words, the wireless communication device may assume that no MCS is configured for each of the baseband data stream signals of the user u.

In step S606, the wireless communication device may calculate a power change ΔP(u,n) for improving the MCS (e.g., increasing the value of the MCS index by 1, that is, increasing the spectral efficiency of the nth baseband data stream signal) for the nth baseband data stream signal of the user u based on the initial MCS index and the lookup table, as shown in equation (4).

$$Δ P ( u , n ) = \frac{IncreasedSNR ( MCS ( u , n ) + 1 ) {Noise}_{eff} ( u , n )}{IncreasedSE ( MCS ( u , n ) + 1 ) {CH}_{eff} ( u , n )} \qquad ( 4 )$$

After completing step S606, the wireless communication device may adjust the MCS of one or more baseband data stream signals of one or more users according to the power change ΔP(u,n) to increase the spectral efficiency of the one or more baseband data stream signals.

Assuming the number of baseband data stream signals for the user u is 1 (i.e., n_{s,u}=1), the wireless communication device may set the MCS index of the baseband data stream signal to a preset MCS index index_{D} (i.e., MCS(u,n_{s,u})=Index_{D}) in step S607. The MCS with the index Index_{D} may satisfy the spectral efficiency requirement for the user allocated merely one baseband data stream signal. For example, if the minimum spectral efficiency requirement for the user is SE=3.7037 bps/Hz, then Index_{D} may equal MCS 10 (i.e., 32APSK) as shown in Table 2. If the MCS index of the user's baseband data stream signal is configured as 9 (i.e., 16APSK), the spectral efficiency of the user is not able to meet 3.7037 bps/Hz.

On the other hand, if the number of baseband data stream signals for the user u is greater than 1, the wireless communication device may repeatedly execute steps S608 to S611 to gradually adjust the MCS of one or more baseband data stream signals until the sum of spectral efficiencies of all baseband data stream signals for the user u reaches the preset value SE. After the sum of spectral efficiencies for the user u reaches the preset value SE, the wireless communication device may update the MCS of the baseband data stream signals for the user u.

In step S608, the wireless communication device may select the n*th baseband data stream signal from n_{s,u} baseband data stream signals of the user u, such that a power change ΔP(u,n*) is minimized, as shown in equation (5). In other words, compared to the power required to increase the spectral efficiencies of other baseband data stream signals, the power required to increase the spectral efficiency of the n*th baseband data stream signal is less.

$${n}^{*} = {arg min}_{n} Δ P ( u , n ) \qquad ( 5 )$$

In step S609, the wireless communication device may increase the index value of the MCS for the n*th baseband data stream signal by 1, such that MCS(u,n*)=MCS(u,n*)+1. After updating the MCS of the n*th baseband data stream signal, the spectral efficiency of the n*th baseband data stream signal increases.

In step S610, the wireless communication device may update the power change ΔP(u,n*) according to the updated MCS index MCS(u,n*), as shown in equation (6).

$$Δ P ( u , {n}^{*} ) = \frac{IncreasedSNR ( MCS ( u , {n}^{*} ) + 1 ) {Noise}_{eff} ( u , {n}^{*} )}{IncreasedSE ( MCS ( u , {n}^{*} ) + 1 ) {CH}_{eff} ( u , {n}^{*} )} \qquad ( 6 )$$

In step S611, the wireless communication device may update the preset value SE according to the updated MCS index MCS(u,n*), such that SE=SE−IncreasedSE(MCS(u,n*)). The wireless communication device may repeatedly execute steps S608 to S611 until the updated SE≤0 (i.e., the sum of spectral efficiencies of all baseband data stream signals for the user u reaches the initial preset value SE, for example, reaching 3.7037 bps/Hz), as shown in equation (7), where S(MCS(u,n)) is the spectral efficiency of the nth baseband data stream signal of the user u.

$${\sum }_{n = 1}^{{n}_{s , u}} S ( MCS ( u , n ) ) \geq SE \qquad ( 7 )$$

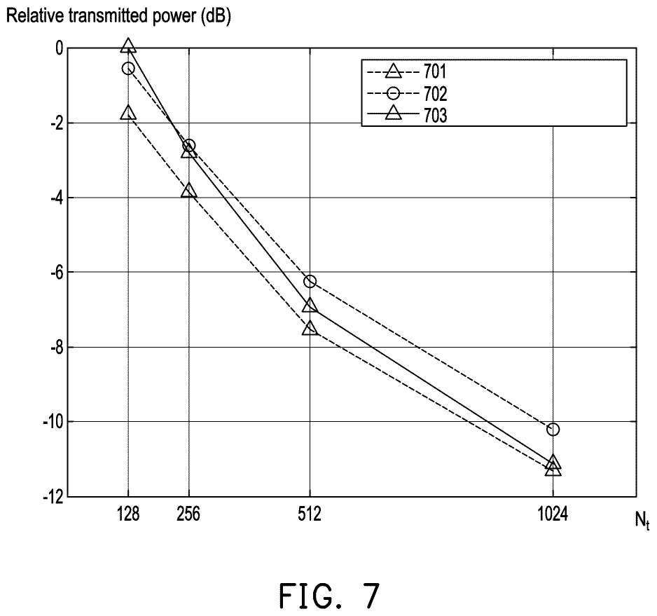

FIG. 7 illustrates simulation results of wireless communication performance according to an embodiment of the disclosure. The simulation in FIG. 7 assumes a system bandwidth of 54 MHz, and each of users needs to achieve a data rate of 200 Mbps at FER=10⁻⁵. Curve 701 represents the relative transmitted power of a hybrid beamforming system using the algorithms 300, 500, and 600 of the disclosure. Curve 702 represents the relative transmitted power of a hybrid beamforming system without using the method of the disclosure. Curve 703 represents the relative transmitted power of a fully-digital block diagonalization system without using the method of the disclosure. From the simulation results, it may be known that compared to conventional methods, the method of the disclosure may reduce transmission power by about 20%.

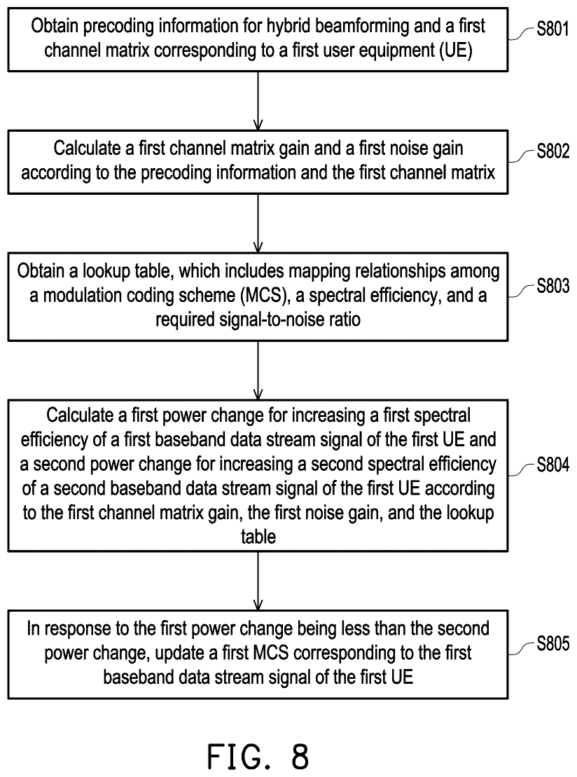

FIG. 8 illustrates a flowchart of a method of configuring a radio resource in satellite communication according to an embodiment of the disclosure, in which the method may be implemented by the wireless communication device, satellite 100, or UE 200 of the disclosure. In step S801, precoding information for hybrid beamforming and a first channel matrix corresponding to a first user equipment (UE) are obtained. In step S802, a first channel matrix gain and a first noise gain are calculated according to the precoding information and the first channel matrix. In step S803, a lookup table is obtained, and the lookup table includes mapping relationships among a modulation coding scheme (MCS), a spectral efficiency, and a required signal-to-noise ratio (SNR). In step S804, a first power change for increasing a first spectral efficiency of a first baseband data stream signal of the first UE and a second power change for increasing a second spectral efficiency of a second baseband data stream signal of the first UE are calculated according to the first channel matrix gain, the first noise gain, and the lookup table. In step S805, in response to the first power change being less than the second power change, a first MCS corresponding to the first baseband data stream signal of the first UE is updated.

In summary, the satellite communication system of the disclosure may include one or more satellites and one or more wireless communication devices such as UE. The wireless communication device may include an analog precoder and a digital precoder for hybrid beamforming. The satellite communication system may configure the analog precoder for each of the wireless communication devices. In the case where the satellite can provide a limited baseband data stream, the satellite communication system may allocate an appropriate number of the baseband data streams to the UE based on the communication quality of the UE. The UE with poorer communication quality may be allocated more baseband data streams to ensure the quality of service of the UE.

After completing the design of the analog precoders and the allocation of the number of the baseband data streams for the satellite and the UE, the satellite communication system may generate digital precoders for the satellite and the UE to improve inter-interference between the UE and intra-interference between data streams.

After completing the design of the precoders and the allocation of the number of the baseband data streams, for the UE allocated with multiple baseband data streams, the satellite communication system may calculate the power required to improve the MCS of each of the baseband data streams. The satellite communication system may gradually improve the MCS of the baseband data stream corresponding to the minimum power change until the spectral efficiencies of all baseband data streams of the UE meet the user requirements. Accordingly, the satellite communication system may improve the communication quality of the UE while minimizing the transmission power.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method of configuring a radio resource in satellite communication, comprising:
obtaining precoding information for hybrid beamforming and a first channel matrix corresponding to a first user equipment;
calculating a first channel matrix gain and a first noise gain according to the precoding information and the first channel matrix;
obtaining a lookup table, wherein the lookup table comprises mapping relationships among a modulation coding scheme, a spectral efficiency, and a required signal-to-noise ratio;
calculating a first power change for increasing a first spectral efficiency of a first baseband data stream signal of the first user equipment and a second power change for increasing a second spectral efficiency of a second baseband data stream signal of the first user equipment according to the first channel matrix gain, the first noise gain, and the lookup table; and
in response to the first power change being less than the second power change, updating a first modulation coding scheme corresponding to the first baseband data stream signal of the first user equipment.

2. The method according to claim 1, wherein updating the first modulation coding scheme corresponding to the first baseband data stream signal of the first user equipment comprises:
increasing a first spectral efficiency corresponding to the first baseband data stream signal of the first user equipment.

3. The method according to claim 2, further comprising:
calculating a sum of a plurality of spectral efficiencies, wherein the plurality of spectral efficiencies respectively correspond to a plurality of baseband data stream signals of the first user equipment; and
in response to the sum reaching a preset value, stopping an update of a plurality of modulation coding schemes respectively corresponding to the plurality of baseband data stream signals.

4. The method according to claim 1, wherein the precoding information comprises a digital precoder and an analog precoder of a satellite, and comprises a digital precoder and an analog precoder of the first user equipment.

5. The method according to claim 1, further comprising:
allocating at least one baseband data stream signal for each of a plurality of user equipments, wherein the plurality of user equipments comprises the first user equipment, and the at least one baseband data stream signal comprises the first baseband data stream signal;
performing singular value decomposition respectively on a plurality of equivalent channel matrices to obtain a singular value set, wherein the plurality of equivalent channel matrices respectively correspond to the plurality of user equipments;
removing a plurality of maximum singular values respectively corresponding to the plurality of equivalent channel matrices from the singular value set to update the singular value set; and
allocating the second baseband data stream signal for the first user equipment according to the singular value set updated.

6. The method according to claim 5, wherein allocating the second baseband data stream signal for the first user equipment according to the singular value set updated comprises:
selecting a plurality of maximum singular values respectively corresponding to the plurality of user equipments from the singular value set updated;
determining whether a first singular value corresponding to the first user equipment is the smallest among the plurality of maximum singular values selected;
in response to determining that the first singular value is the smallest, allocating the second baseband data stream signal for the first user equipment; and
removing the first singular value from the singular value set to update the singular value set.

7. The method according to claim 5, further comprising:
determining a number n_{s,u} of baseband data streams allocated to the first user equipment according to the singular value set, where n_{s,u} is a positive integer;
calculating an equivalent channel matrix according to an analog precoder of the first user equipment and the first channel matrix;
performing singular value decomposition on the equivalent channel matrix to obtain first n_{s,u} right singular vectors; and
generating an analog precoder of a satellite according to the first n_{s,u} right singular vectors.

8. The method according to claim 1, further comprising:
performing singular value decomposition on the first channel matrix to obtain first N_{rRF} left singular vectors, where N_{rRF} is a positive integer; and
generating an analog precoder of the first user equipment according to the first N_{rRF} left singular vectors.

9. The method according to claim 1, wherein the precoding information comprises an analog precoder of a satellite and an analog precoder of the first user equipment, and the method further comprises:
calculating a first equivalent channel matrix according to the first channel, the analog precoder of the satellite, and the analog precoder of the first user equipment;
performing singular value decomposition on the first equivalent channel matrix to obtain first n_{s,u} left singular vectors, where n_{s,u} is a number of baseband data stream signals allocated to the first user equipment, and n_{s,u} is a positive integer; and
generating a digital precoder of a second user equipment according to the first n_{s,u} left singular vectors.

10. The method according to claim 9, wherein generating the digital precoder of the second user equipment according to the first n_{s,u} left singular vectors comprises:
generating a second equivalent channel matrix according to the first n_{s,u} left singular vectors and the first equivalent channel matrix;
generating a third equivalent channel matrix, wherein the third equivalent channel matrix comprises a plurality of equivalent channel matrices different from a fourth equivalent channel matrix, and the fourth equivalent channel matrix corresponds to the second user equipment;
performing singular value decomposition on the third equivalent channel matrix to obtain last (N_{tRF}−rank ( [symbol] )) right singular vectors, where N_{tRF} is a number of radio frequency chains of the satellite, and rank ( [symbol] ) is rank of the third equivalent channel matrix;
generating a fifth equivalent channel matrix according to the last (N_{tRF}−rank ( [symbol] )) right singular vectors and the second equivalent channel matrix;
performing singular value decomposition on the fifth equivalent channel matrix to obtain first n_{s,u} second left singular vectors, where n_{s,u} is a number of baseband data stream signals allocated to the first user equipment, and n_{s,u} is a positive integer; and
generating the digital precoder of the second user equipment according to the first n_{s,u} left singular vectors and the first n_{s,u} second left singular vectors.

11. The method according to claim 10, further comprising:
performing the singular value decomposition on the fifth equivalent channel matrix to obtain first n_{s,u} right singular vectors; and
generating a digital precoder of the satellite according to the last (N_{tRF}−rank( [symbol] )) right singular vectors and the first n_{s,u} right singular vectors.

12. A wireless communication device of configuring a radio resource in satellite communication, comprising:
a processor;
a digital precoding circuit, coupled to the processor;
a plurality of radio frequency chains, coupled to the digital precoding circuit; and
an analog precoding circuit, coupled to the plurality of radio frequency chains, wherein the processor is configured to execute:
obtaining precoding information for hybrid beamforming and a first channel matrix corresponding to a first user equipment;
calculating a first channel matrix gain and a first noise gain according to the precoding information and the first channel matrix;
obtaining a lookup table, wherein the lookup table comprises mapping relationships among a modulation coding scheme, a spectral efficiency, and a required signal-to-noise ratio;
calculating a first power change for increasing a first spectral efficiency of a first baseband data stream signal of the first user equipment and a second power change for increasing a second spectral efficiency of a second baseband data stream signal of the first user equipment according to the first channel matrix gain, the first noise gain, and the lookup table; and
in response to the first power change being less than the second power change, updating a first modulation coding scheme corresponding to the first baseband data stream signal of the first user equipment.

13. The wireless communication device according to claim 12, wherein the wireless communication device comprises one of a satellite and the first user equipment.
